(19) United States
(12) Patent Application Publication
(10) Pub. No.: US 2018/0037105 A1
(43) Pub. Date: Feb. 8, 2018

(54) REINFORCED FUEL TANK

(71) Applicant: Ford Global Technologies, LLC, Dearborn, MI (US)

(72) Inventors: Russell Randall Pearce, Ann Arbor, MI (US); Daniel Frank Cragel, Livonia, MI (US)

(21) Appl. No.: 15/228,165

(22) Filed: Aug. 4, 2016

(51) Int. Cl. B60K 15/03

(52) U.S. Cl. CPC B60K 15/03; B60K 2015/03453

(57) ABSTRACT

A fuel tank is provided. The fuel tank includes a housing enclosing a fuel, the housing including a reinforcement region having two opposing interior surfaces in face sharing contact with one another and a mechanical fastener extending through the reinforcement region, the mechanical fastener including a first head positioned within an external depression of the reinforcement region.

### BACKGROUND/SUMMARY

In vehicle fuel tanks, a section of the top and bottom of the fuel tank may be joined to form an indented shape, referred to as a flower pot. This connected structure provides reinforcement to the fuel tank in selected regions. Reinforcing tank structures may be particularly beneficial in fuel tanks having complex shapes and experiencing high pressures. However, the indented structure can fatigue overtime when it is not formed to precise specifications. Additionally, liquid originating from other engine components, systems, the external environment, etc., may accumulate in the external cavity formed by the contour of the indentation. The accumulated liquid may contain water as well as corrosive fluids that can degrade the fuel tank housing. As such, indented fuel tank reinforcing structures have several drawbacks.

To address at least some of the aforementioned problems, a fuel tank is provided. The fuel tank includes a housing enclosing a fuel, the housing including a reinforcement region having two opposing interior surfaces in face sharing contact with one another and a mechanical fastener extending through the reinforcement region, the mechanical fastener including a first head positioned within an external depression of the reinforcement region. The mechanical fastener acts to decrease stress on the joined region, thereby increasing the structural integrity of the fuel tank. As such, the fuel tank's durability is increased and the likelihood of fuel tank deformation is decreased.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic depiction of an engine with a fuel delivery system;

FIG. 2 shows an illustration of a fuel tank included in the fuel delivery system shown in FIG. 1;

FIG. 3 shows a cross-sectional view of the fuel tank depicted in FIG. 2;

FIG. 4 shows an expanded view of a portion of the fuel tank cross-section shown in FIG. 3;

FIG. 5 shows another example of a mechanical fastener in the fuel tank;

FIG. 6 shows an illustration of another fuel tank included in the fuel delivery system shown in FIG. 1; and

FIG. 7 shows another cross-sectional view of the fuel tank depicted in FIG. 2.

### DETAILED DESCRIPTION

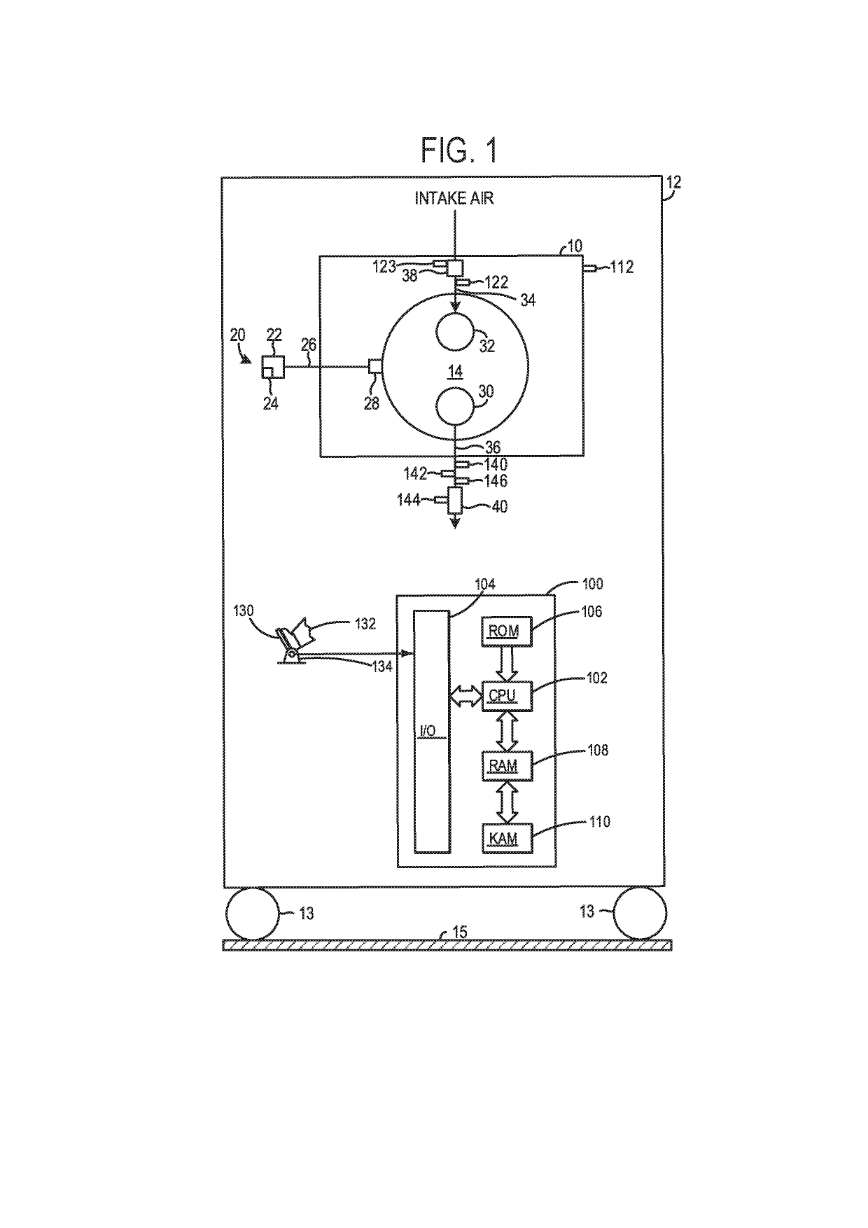

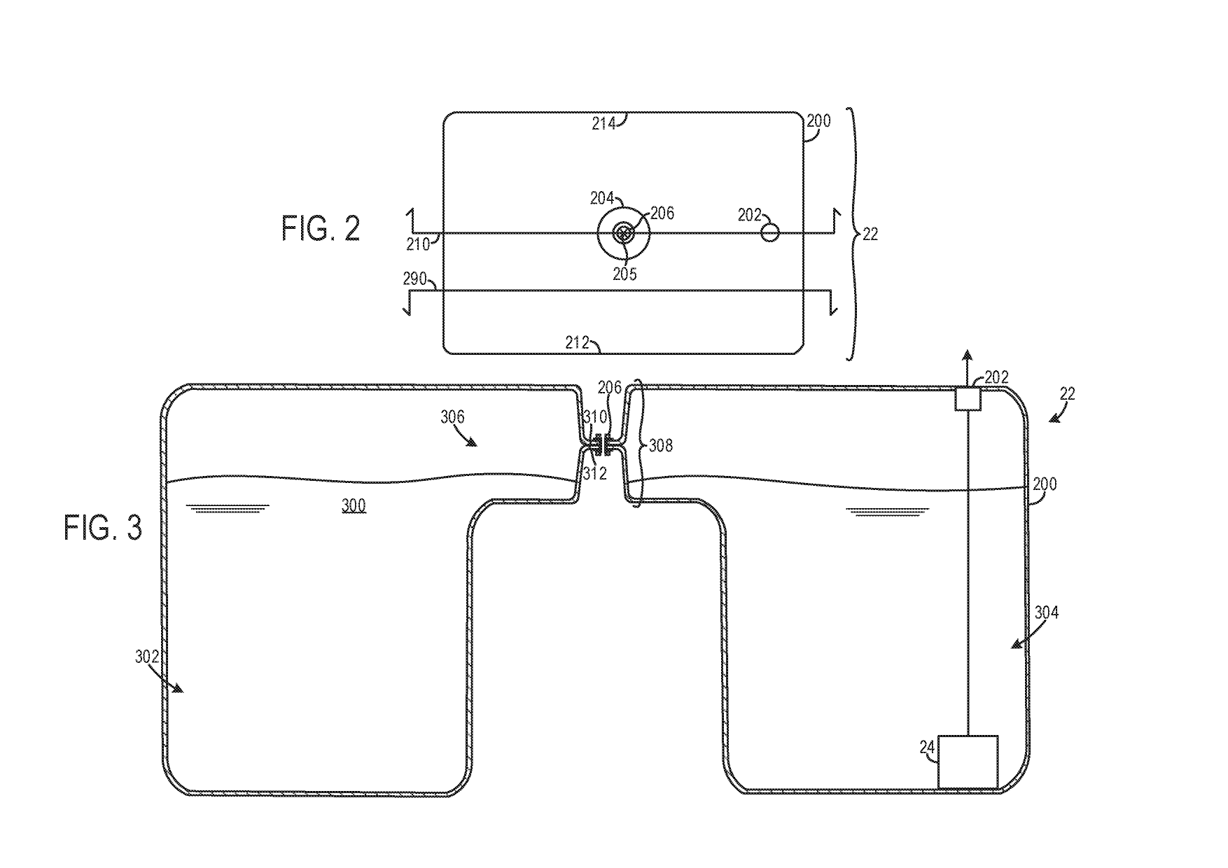

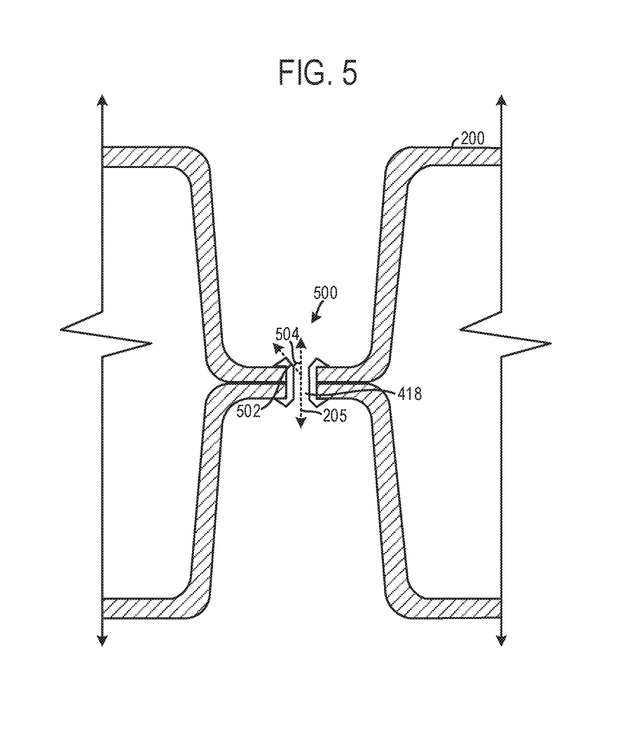

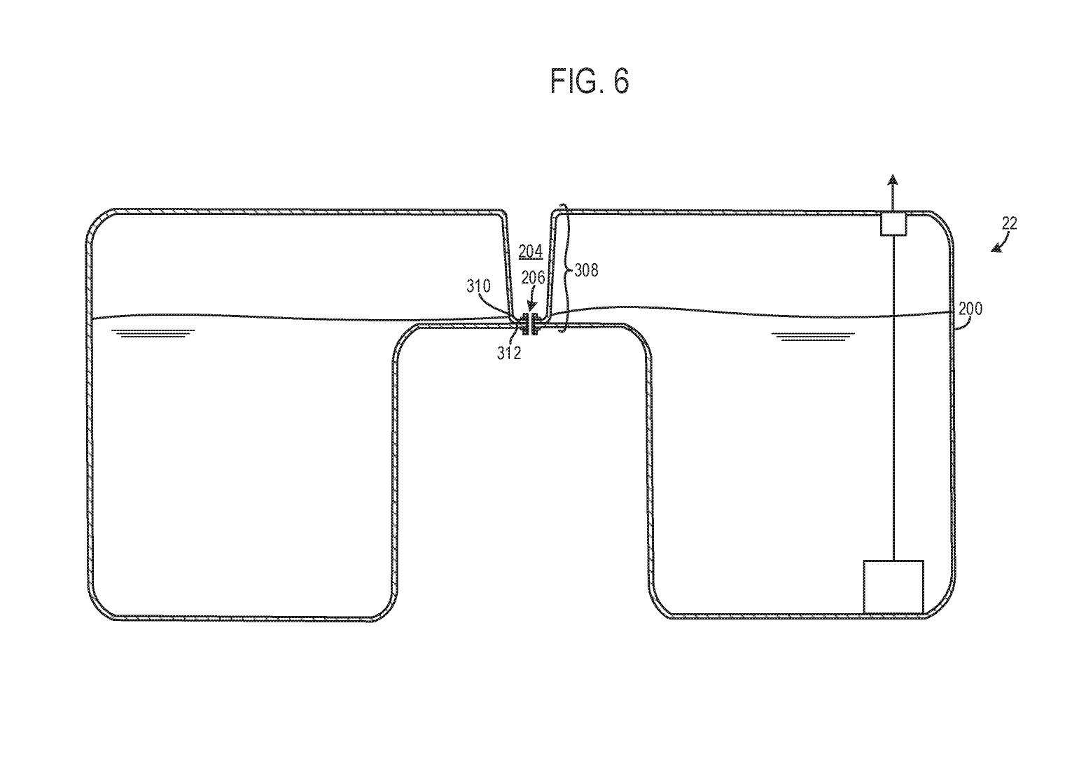

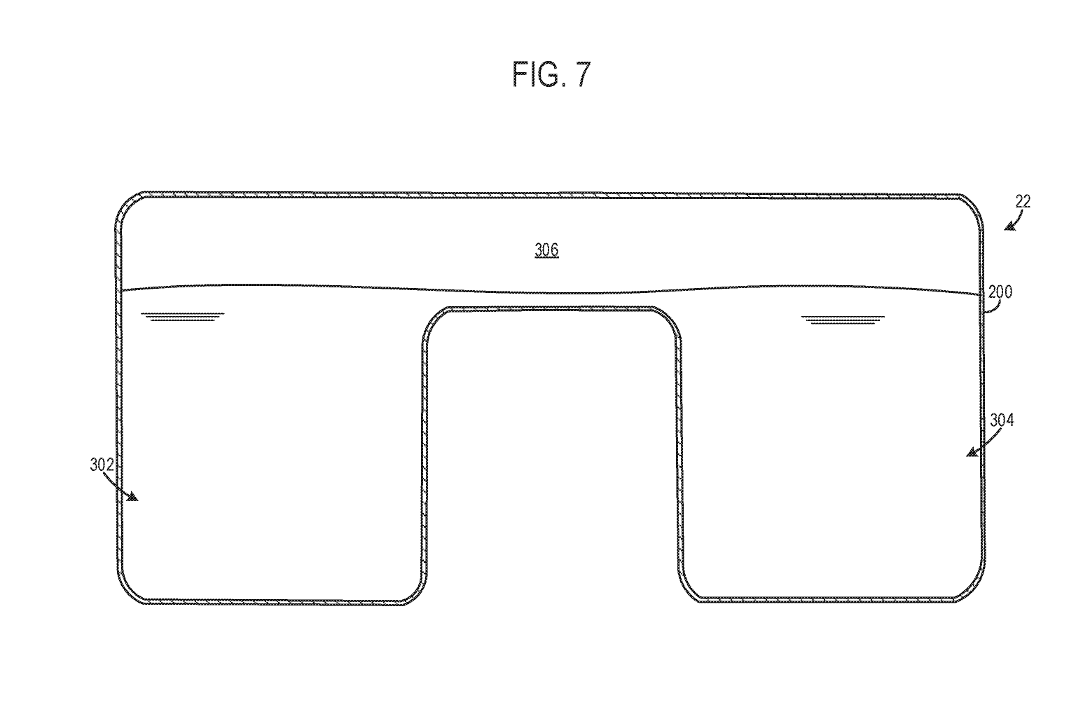

A fuel tank with increased support of a selected region, referred to as a reinforcement region, and a drainage feature for an external depression caused by the contour of the reinforcement region is discussed herein. The improved tank reinforcement and drainage features are achieved by placing a mechanical fastener, such as a rivet, through a reinforcement region where two opposing sections of a housing of the fuel tank are in contact with one another. The mechanical fastener acts to strengthen the reinforcement region, thereby increasing the fuel tank's durability and longevity and decreasing the likelihood of fuel tank deformation. Washer plates may be provided between the mechanical fastener and external surfaces of the reinforcement region to more evenly distribute loads on the fuel tank housing from the mechanical fastener. Thus, the washer plates provide greater load dispersion, further improving the structural integrity of the fuel tank. Additionally, in one example the mechanical fastener may include a drain channel enabling liquid accumulated in the external depression in the fuel tank housing to flow through the mechanical fastener and drain away from the tank to avoid excessive liquid accumulation in external regions of the fuel tank. In this way, the mechanical fastener can provide both the function of a reinforcing the tank's housing but also act a drain for external recesses in the fuel tank, which can be particularly advantageous in mobile road vehicles where water may accumulate even on top surfaces (with respect to ground/gravity) as water can splash up and/or leak into the region of the recess from above. Additionally, the mechanical fastener drain decreases the likelihood of fuel tank housing corrosion caused by accumulated liquids (e.g., water, oil, etc.,) in the external indentation in the fuel tank. FIG. 1 shows a schematic depiction of an engine and fuel delivery system, FIGS. 2-4 shows different views of a fuel tank included in the fuel delivery system shown in FIG. 1 with a reinforcement region with a mechanical fastener extending therethrough. FIG. 5 shows another example of a mechanical fastener in the fuel tank housing. FIG. 6 shows another exemplary fuel tank with a mechanical fastener and reinforcement region. FIG. 7 shows another cross-section of the fuel tank depicted in FIG. 2.

FIG. 1 shows a schematic depiction of an internal combustion engine 10 in a vehicle 12 with at least one cylinder 14 and is controlled by an electronic engine controller 100. In the depicted example, the vehicle 12 is a wheeled road vehicle including wheels 13 in contact with a road 15. However, other types of vehicles other than wheeled vehicles have been contemplated. Additionally, in the depicted example the road 15 is substantially flat. However it will be appreciated that the vehicle may travel over roads or other surfaces having any type of conceivable profile. Engine 10 includes the cylinder 14 with a piston (not shown) positioned therein and connected to a crankshaft (not shown).

A fuel delivery system 20 configured to provide metered fuel at desired time intervals to the cylinder 14 is included in the vehicle 12. The fuel delivery system 20 includes a fuel tank 22 configured to store fuel (e.g., gasoline, diesel, alcohol, combinations thereof, etc.) The fuel tank 22 is schematically depicted in FIG. 1. However, it will be appreciated that the fuel tank 22 has greater complexity that is discussed in greater detail herein. The fuel delivery system 20 also includes a fuel pump 24. In the depicted example, the fuel pump 24 is enclosed in the fuel tank 22. It will be appreciated that in other examples the fuel pump 24 may be positioned external to the fuel tank 22. Further in some examples, additional fuel pumps may be included in the fuel delivery system 20. For instance, the fuel delivery system 20 may include a lift pump and a higher pressure fuel pump. However numerous fuel delivery system pump arrangements have been contemplated. The fuel delivery system 20 also includes a fuel line 26 coupling the fuel tank 22 to a fuel injector 28. The fuel injector 28 is shown coupled to the cylinder 14. Additionally or alternatively a port injector may be included in the engine 10. The fuel delivery system 20 can include additional components that are not depicted in FIG. 1 such as check valves, a fuel rail, a return line, etc.

During operation, each cylinder within engine 10 typically undergoes a four-stroke cycle: the cycle includes an intake stroke, compression stroke, expansion stroke, and exhaust stroke. During the intake stroke, generally, an exhaust valve 30 closes and intake valve 32 opens. Air is introduced into the cylinder 14 via an intake conduit 34 (e.g., intake manifold), and the piston moves to the bottom of the cylinder to increase the volume within cylinder 14. The position at which piston is near the bottom of the cylinder and at the end of its stroke (e.g., when cylinder is at its largest volume) is typically referred to by those of skill in the art as bottom dead center (BDC). During the compression stroke, the intake valve 32 and the exhaust valve 30 are closed. The piston moves toward the cylinder head to compress the air within the cylinder 14. The point at which the piston is at the end of its stroke and closest to the cylinder head (e.g., when cylinder 14 is at its smallest volume) is typically referred to by those of skill in the art as top dead center (TDC). In a process hereinafter referred to as injection, fuel is introduced into the cylinder. In a process hereinafter referred to as ignition, the injected fuel is ignited by known ignition means such as a spark plug or compression, resulting in combustion. During the expansion stroke, the expanding gases push the piston back to BDC. The crankshaft converts piston movement into a rotational torque of the rotary shaft. Finally, during the exhaust stroke, the exhaust valve 30 opens to release the combusted air-fuel mixture to exhaust conduit 36 (e.g., exhaust manifold) and the piston returns to TDC. Note that the above is shown merely as an example, and that intake and exhaust valve opening and/or closing timings may vary, such as to provide positive or negative valve overlap, late intake valve closing, or various other examples. Further, the engine may be a compression ignition engine configured to operate with diesel fuel, for example, and thus during operation ignition via spark plug may be dispensed with.

The engine 10 also includes a throttle 38 configured to adjust the amount of air provided to the cylinder 14 through the intake conduit 34 via the intake valve 32. The engine also includes an emission control device 40 positioned downstream of the exhaust valve 30 in the exhaust conduit 36. Additional components may be included in the engine 10 such as additional conduits, a compressor, an intake manifold, etc., that assist in providing intake air to the cylinder and/or provide other useful functions such as providing boost, cooling, etc.

Controller 100 is shown in FIG. 1 as a conventional microcomputer including: microprocessor unit 102, input/output ports 104, read-only memory 106, random access memory 108, keep alive memory 110, and a conventional data bus. Controller 100 is shown receiving various signals from sensors coupled to engine 10, in addition to those signals previously discussed, including: engine coolant temperature (ECT) from temperature sensor 112 coupled to a cooling sleeve, a position sensor 134 coupled to an accelerator pedal 130 for sensing force applied by foot 132; a measurement of engine manifold pressure (MAP) from pressure sensor 122 coupled to the intake conduit 34; an engine position sensor from a Hall effect sensor (not shown) sensing crankshaft position; and a measurement of throttle position from sensor 123. Barometric pressure may also be sensed (sensor not shown) for processing by controller 100. Controller 100 may also receive signals from sensors located in the engine 10 such as exhaust gas composition sensor 140, temperature sensor 142, catalyst bed sensor 144 configured to determine catalyst oxidation, and/or airflow sensor 146. The controller 100 may also be configured to trigger one or more actuators in the engine 10 and specifically the fuel delivery system 20. For instance, the controller 100 may be configured to adjust the throttle 38, fuel injector 28, fuel pump 24, etc. Therefore, the controller 100 receives signals from the various sensors of FIG. 1 and employs the various actuators of FIG. 1 to adjust engine operation based on the received signals and instructions stored in memory of the controller.

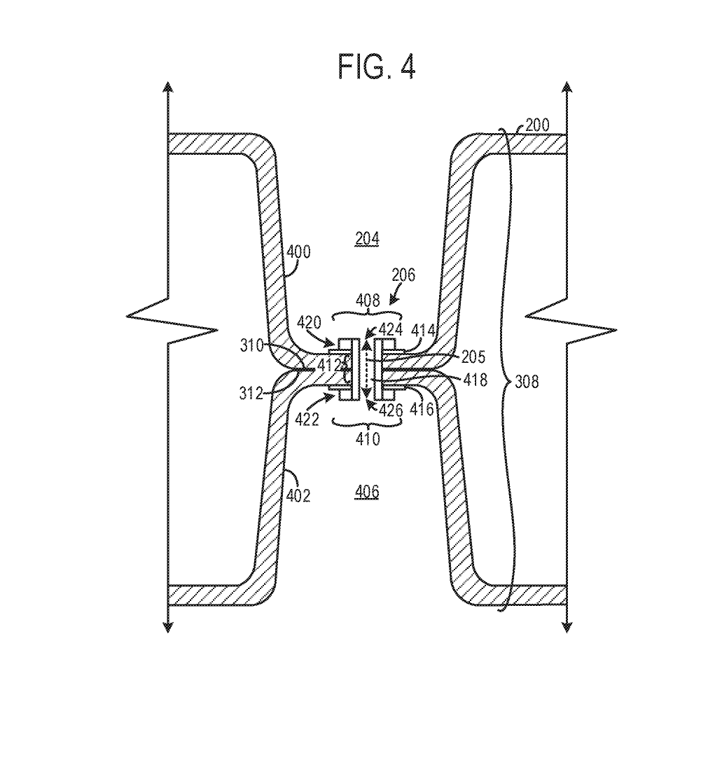

FIG. 2 shows a top view of a detailed illustration of the fuel tank 22. The fuel tank 22 includes a housing 200 and an outlet 202 in fluidic communication with the fuel injector 28 shown in FIG. 1. Continuing with FIG. 2, the housing 200 of the fuel tank 22 also includes a first external depression 204. A mechanical fastener 206 extending through the housing 200 is also shown in FIG. 2. The mechanical fastener 206 provides reinforcement to the first external depression 204, thereby increasing the structural integrity of the fuel tank 22. The first external depression 204 has a circular geometry with regard to an axis 205 extending through the mechanical fastener 206. However, other geometries of the first external depression 204 have been contemplated such as oval shapes, square shapes, rectangular shapes, etc. Cutting plane 210 defines the cross-sectional view shown in FIGS. 3 and 4.

Note that, as discussed with regard to FIG. 3, for example, the particular cross section shown has an indented recess (from both the top and bottom in this example, but it may be only from the top, if desired, see FIG. 6). As such in the fuel tank illustrated in FIG. 6 the housing 200 only includes the first external depression 204. Additionally, while the figure shows only a single indented recess, multiple recesses may be present. In cross-sections where there is not a recess, both sides of the tank communicate via an open channel between the two sides. For example, as cross-section 290, as shown in FIG. 7, the connecting region is open to each side.

Turning now specifically to FIG. 3, it shows a cross-sectional view of the fuel tank 22. The fuel tank outlet 202 is also depicted in FIG. 3. As previously discussed, the fuel tank outlet 202 is fluidly coupled to the fuel injector 28 shown in FIG. 1. Continuing with FIG. 3, the fuel pump 24 is in fluidic communication with the fuel tank outlet 202. The fuel pump 24 is configured to increase the pressure of fuel and transfer fuel to the fuel tank outlet 202 and other downstream fuel delivery system components.

A fuel 300 is shown enclosed in the housing 200 of the fuel tank 22. The housing 200 has a saddle shape with a first region 302 and a second region 304 joined by connecting region 306. It will be appreciated that the housing 200 is shaped such that fuel can flow between the first region 302, the second region 304, and the connecting region 306. Although, the housing is shaped with a saddle shape other fuel tank geometries have been contemplated.

The housing 200 includes a reinforcement region 308 with a first interior surface 310 and a second interior surface 312 opposing the first in face sharing contact with one another. In one specific example, the first and second interior surfaces 310 and 312 may be welded, glued, etc., to one another. However in other examples, the interior surface may simply be in contact with one another.

The mechanical fastener 206 is shown extending through the section of the reinforcement region 308 where the first and second interior surfaces 310 and 312 are in face sharing contact. The mechanical fastener 206 acts to reinforce a selected section of the housing 200 to further strengthen the fuel tank 22 and reduce fatigue on the tank caused by various factors such as high pressures, structural loads from other engine components, etc.

FIG. 4 shows a detailed view of the reinforcement region 308 with the mechanical fastener 206 extending therethrough. The first and second interior surfaces 310 and 312 of the reinforcement region 308 are illustrated. Exterior surfaces 400 and 402 included in the reinforcement region 308 are also shown. The profile of the exterior surfaces 400 and 402 form the first external depression 204 and a second external depression 406. The mechanical fastener 206 includes a first head 408 and a second head 410 coupled to a shaft 412 (e.g., cylindrical shaft). Specifically in one example, the mechanical fastener 206 may be a rivet where the heads 408 and 410 are non-removably attached to the shaft 412. However, other types of mechanical fasteners have been contemplated such as mechanical fasteners with removable heads.

The first head 410 is positioned in the first external depression 204 and the second head 412 is positioned in the second external depression 406. That is to say that sections of the external surfaces 400 and 402 circumferentially enclose each respective head 408 and 410. The first and second heads 408 and 410 have a greater diameter than the diameter of the shaft 412. The aforementioned diameters are measured from the axis 205. In one example, the axis 205 may be parallel to a vertical axis when the vehicle in which the fuel tank 22 located is on a level surface. Forming the mechanical fastener 206 with the heads 408 and 410 having a greater diameter than the shaft 412 enables movement of the mechanical fastener 206 to be reduced and load dispersion to the housing 200 from the fastener to be increased. Load dispersion may be further increased via washer plates 414 and 416 positioned between respective heads 408 and 410 and exterior surfaces 400 and 402. The washer plates 414 and 416 may have an annular shape, in one example. Additionally, the washer plates 414 and 416 have a larger diameter than the heads 408 and 410 of the mechanical fastener 206. Again the diameter of the washer plates 414 and 416 is measured from the axis 205. In this way, loads transferred from the mechanical fastener 206 to the housing 200 can be distributed over a greater area of the housing, thereby increasing load dispersion. As a result, the likelihood of fuel tank deformation is decreased and fuel tank durability is increased.

Additionally, the shaft 412 extends through the first and second interior surfaces 310 and 312 to the exterior surfaces 402 and 404 of the reinforcement region 308. The mechanical fastener 206 also includes a drain channel 418 extending from a first end 420 of the mechanical fastener 206 to a second end 422 of the mechanical fastener 206. Although it appears that the drain channel 418 splits the mechanical fastener 206 into two sections this is not the case. Rather, the apparent sections of the mechanical fastener 206 are coupled via a continuous section of the fastener extending therebetween.

Specifically in the depicted example, the axis 205 is also the central axis of the drain channel 418. The axis 205 can be vertically aligned with respect to gravity when the fuel tank 22 is positioned in the wheeled road vehicle 12 positioned on a flat road 15, shown in FIG. 1. Continuing with FIG. 4, the drain channel's central axis is defined from the drain channel's vertical top most opening (i.e., the first opening 424) to its bottom most opening (i.e., the second opening 426). Furthermore, the drain channel 418 has no other openings in the depicted example. However, a drain channel having opening other than the openings depicted in FIG. 4 have been contemplated. It will be appreciated that the drain channel 418 enables water and/or other liquids to drain from vertically above to below through the channel without a pump or other air pressure generating devices but via gravity. However, in other examples a pump, air pressure, etc., may be used to assist in draining the external depression.

The drain channel 418 is fluidly separated from the fuel enclosed by the housing 200. The drain channel 418 includes a first opening 424 at the first end 420 of the fastener and a second opening 426 as the second end 422 of the fastener. It will be appreciated that the openings extend through sections of the first and second heads 408 and 410, respectively. The first opening 424 opens into the first external depression 204 and the second opening 426 opens into the second external depression 406. In this way, fluid may be drain from the first external depression 204 through the drain channel 418 and away from the second external depression 406 when the fuel tank is vertically aligned. As a result, fluid accumulated in external recesses in the housing 200 can be reduced (e.g., substantially eliminated). Consequently, the likelihood of corrosion of the housing 200 caused by the accumulated liquid which in some cases can be corrosive is reduced. In other examples, such as an example where the vertical axis extends towards the bottom of the page, fluid may drain in the opposing direction.

In one example, the housing 200 is contoured to permit fuel to flow around the reinforcement region 308. That is to say that the connection between the interior surfaces 310 and 312 does not extend all the way to the sides 212 and 214 of the housing 200, the sides 212 and 214 being denoted in FIG. 2. In this way, the reinforcement region 314 does not divide the fuel tank into different sealed chambers but conversely enables fuel to flow between different interior regions of the fuel tank.

Continuing with FIG. 4, in one example the mechanical fastener 206 and the housing 200 may be constructed out of different materials. In such an example, the housing 200 may be constructed out of a polymeric material and the mechanical fastener may be constructed out of a metal or vice versa. In other example, the housing 200 and the mechanical fastener 206 may be constructed out of similar materials.

FIG. 5 shows another exemplary mechanical fastener 500 extending through the housing 200. The mechanical fastener 500 share many similarities with the mechanical fastener 206 shown in FIGS. 2-4. As such, similar parts are labelled accordingly and redundant description of elements of the fastener is omitted. The mechanical fastener 500 includes a surface 502 extending inward towards the axis 205 (e.g., central axis) of the mechanical fastener 500 at an angle 504 of less than 90 degrees with regard to the axis 205. The surface 502 enables fluid to flow into the drain channel 418 more easily.

FIGS. 1-6 show example configurations with relative positioning and sizing of the various components, although modifications may be made including changing the relative scaling and positioning of the components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example,

The subject matter of the present disclosure is further described in the following paragraphs. According to one aspect, a reinforced fuel tank is provided. The reinforced fuel tank includes a housing enclosing a fuel, the housing including a reinforcement region having two opposing interior surfaces in face sharing contact with one another and a mechanical fastener extending through the two opposing interior surfaces, the mechanical fastener including a first head positioned within an external depression of the reinforcement region.

According to another aspect, a reinforced fuel tank is provided. The reinforced fuel tank includes a housing enclosing a fuel, the housing including a reinforcement region having two opposing interior surfaces in face sharing contact with one another and a rivet extending through the two opposing interior surfaces, the mechanical fastener including a first head contained within an external depression of the reinforcement region.

According to another aspect, a reinforced fuel tank is provided. The reinforced fuel tank includes a housing enclosing a fuel, the housing including a reinforcement region where two opposing interior surfaces are in face sharing contact, a rivet extending through the two opposing interior surfaces, the mechanical fastener including a first head contained within an external depression of the reinforcement region, and a washer plate positioned between the first head of the mechanical fastener and an outer surface of the housing.

In any of the aspects described herein or combinations of the aspects, the mechanical fastener can include a drain channel extending from a first end of the mechanical fastener to a second end of the mechanical fastener and fluidly separated from the fuel enclosed by the housing.

In any of the aspects described herein or combinations of the aspects, the drain channel can include a first opening at the first end of the mechanical fastener and a second opening at the second end of the mechanical fastener.

In any of the aspects described herein or combinations of the aspects, the first end of the mechanical fastener can include a surface extending inward toward a central axis of the mechanical fastener at an angle less than 90 degrees with regard to the central axis.

In any of the aspects described herein or combinations of the aspects, the mechanical fastener may be a rivet including a second head.

In any of the aspects described herein or combinations of the aspects, the mechanical fastener and the housing may be constructed out of different materials.

In any of the aspects described herein or combinations of the aspects, the housing may be constructed out of a polymeric material and the mechanical fastener is constructed out of a metal.

In any of the aspects described herein or combinations of the aspects, the reinforced fuel tank may further include a washer plate positioned between the first head of the mechanical fastener and an exterior surface of the housing.

In any of the aspects described herein or combinations of the aspects, the housing may be contoured to permit fuel to flow circumferentially around the reinforcement region.

In any of the aspects described herein or combinations of the aspects, the mechanical fastener may include a drain channel extending from a first end of the mechanical fastener to a second end of the mechanical fastener, the drain channel fluidly separated from the fuel enclosed by the housing.

In any of the aspects described herein or combinations of the aspects, the drain channel may include a first opening at the first end of the mechanical fastener and a second opening at the second end of the mechanical fastener and the drain channel may have a central axis therethrough that is vertically aligned with respect to gravity when the fuel tank is positioned in a wheeled road vehicle positioned on a flat road, the central axis defined from the channel's vertical top most opening to its bottom most opening, the channel having no other openings and enabling water to drain from vertically above to below through the channel without a pump or other air pressure generating devices but via gravity.

In any of the aspects described herein or combinations of the aspects, the washer plate may have a larger diameter than the first head of the rivet.

In any of the aspects described herein or combinations of the aspects, the rivet may be constructed out of a different material than the housing.

In any of the aspects described herein or combinations of the aspects, the mechanical fastener may include a drain channel extending from a first end of the mechanical fastener to a second end of the mechanical fastener, the drain channel fluidly separated from the fuel enclosed by the housing and including a first opening at the first end of the mechanical fastener and a second opening at the second end of the mechanical fastener.

Note that the example control routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, 1-4, 1-6, V-12, opposed 4, and other engine types. Further, one or more of the various system configurations may be used in combination with one or more of the described diagnostic routines. The subject matter of the present disclosure includes all novel and non-obvious combinations and sub-combinations of the various systems and configurations, and other features, functions, and/or properties disclosed herein.

1. A reinforced fuel tank comprising:
a housing enclosing a fuel, the housing including a reinforcement region having two opposing interior surfaces in face sharing contact with one another; and
a mechanical fastener extending through the two opposing interior surfaces, the mechanical fastener including a first head positioned within an external depression of the reinforcement region.

2. The reinforced fuel tank of claim 1, where the mechanical fastener includes a drain channel extending from a first end of the mechanical fastener to a second end of the mechanical fastener and fluidly separated from the fuel enclosed by the housing.

3. The reinforced fuel tank of claim 2, where the drain channel includes a first opening at the first end of the mechanical fastener and a second opening at the second end of the mechanical fastener, and where the drain channel has a central axis therethrough that is vertically aligned with respect to gravity when the fuel tank is positioned in a wheeled road vehicle positioned on a flat road, the central axis defined from the channel's vertical top most opening to its bottom most opening, the channel having no other openings and enabling water to drain from vertically above to below through the channel without a pump or other air pressure generating devices but via gravity.

4. The reinforced fuel tank of claim 3, where the first end of the mechanical fastener includes a surface extending inward toward a central axis of the mechanical fastener at an angle less than 90 degrees with regard to the central axis.

5. The reinforced fuel tank of claim 1, where the mechanical fastener is a rivet including a second head.

6. The reinforced fuel tank of claim 1, where the mechanical fastener and the housing are constructed out of different materials.

7. The reinforced fuel tank of claim 6, where the housing is constructed out of a polymeric material and the mechanical fastener is constructed out of a metal.

8. The reinforced fuel tank of claim 1, further comprising a washer plate positioned between the first head of the mechanical fastener and an exterior surface of the housing.

9. The reinforced fuel tank of claim 1, where the housing is contoured to permit fuel to flow circumferentially around the reinforcement region.

10. A reinforced fuel tank comprising:
a housing enclosing a fuel, the housing including a reinforcement region having two opposing interior surfaces in face sharing contact with one another; and
a rivet extending through the two opposing interior surfaces, the mechanical fastener including a first head contained within an external depression of the reinforcement region.

11. The reinforced fuel tank of claim 10, where the mechanical fastener includes a drain channel extending from a first end of the mechanical fastener to a second end of the mechanical fastener, the drain channel fluidly separated from the fuel enclosed by the housing.

12. The reinforced fuel tank of claim 11, where the drain channel includes a first opening at the first end of the mechanical fastener and a second opening at the second end of the mechanical fastener.

13. The reinforced fuel tank of claim 12, where the first end of the mechanical fastener includes a surface extending inward toward a central axis of the mechanical fastener at an angle less than 90 degrees with regard to the central axis.

14. The reinforced fuel tank of claim 10, further comprising a washer plate position between the first head of the mechanical fastener and an exterior surface of the housing.

15. The reinforced fuel tank of claim 14, where the washer plate has a larger diameter than the first head of the rivet.

16. The reinforced fuel tank of claim 10, where the rivet is constructed out of a different material than the housing.

17. A reinforced fuel tank comprising:
a housing enclosing a fuel, the housing including a reinforcement region where two opposing interior surfaces are in face sharing contact;
a rivet extending through the two opposing interior surfaces, the mechanical fastener including a first head contained within an external depression of the reinforcement region; and
a washer plate positioned between the first head of the mechanical fastener and an outer surface of the housing.

18. The reinforced fuel tank of claim 17, where the mechanical fastener includes a drain channel extending from a first end of the mechanical fastener to a second end of the mechanical fastener, the drain channel fluidly separated from the fuel enclosed by the housing and including a first opening at the first end of the mechanical fastener and a second opening at the second end of the mechanical fastener.

19. The reinforced fuel tank of claim 18, where the first end of the mechanical fastener includes a surface extending inward toward a central axis of the mechanical fastener at an angle less than 90 degrees with regard to the central axis.

20. The reinforced fuel tank of claim 17, where the rivet is constructed out of a different material than the housing.
